(19) United States
(12) Patent Application Publication
(10) Pub. No.: US 2013/0067811 A1
(43) Pub. Date: Mar. 21, 2013

(54) PLANT CONTAINER SYSTEM AND METHOD

(71) Applicant: Bruce Baker, Ann Arbor, MI (US)

(72) Inventor: Bruce Baker, Ann Arbor, MI (US)

(73) Assignee: WAY2GRO, LLC, Ann Arbor, MI (US)

(21) Appl. No.: 13/622,600

(22) Filed: Sep. 19, 2012

Related U.S. Application Data
(60) Provisional application No. 61/536,260, filed on Sep. 19, 2011.

(51) Int. Cl. A01G 9/02; A01G 27/06

(52) U.S. Cl. 47/67; 47/81

(57) ABSTRACT

A container system providing ideal watering and aeration conditions for growing plants comprises a tray having a bottom surface. An insert with an upper surface and a lower surface is placed in the tray forming an upper space above the insert for the addition of a growth medium, and a lower space below the insert forming a water reservoir. One or more perforated baskets extending from the lower surface of the insert and into the water reservoir draw water from the reservoir and into the growth medium. At least one aperture in the insert is coupled to a perforated post to provide air circulation to the growth medium. A port may be provided through the insert enabling an inverted water vessel to be coupled to the port to provide water to the water reservoir. The various components may be provided in the form of a kit assembled by a user.

### REFERENCE TO RELATED APPLICATION

This application claims priority to U.S. Provisional Patent Application Ser. No. 61/536,260, filed Sep. 19, 2011, the entire content of which is incorporated herein by reference.

### FIELD OF THE INVENTION

This invention relates generally to container systems for growing plants and, in particular, to growing containers having a self-regulating watering reservoir.

### BACKGROUND OF THE INVENTION

The roots of most ornamental plants, vegetables, and herbs will naturally grow laterally when planted in soil. Root growth is typically confined to the area near the surface of the soil. One reason for this is that moisture, either from irrigation or rain water, is greatest in that area. Roots will seek an area with a steady, reliable source of moisture.

Most ornamental pots and planters hold soil primarily in a vertical orientation, meaning that the ratio of interior wall to base is well above one to one. Any experienced gardener might observe that plants grown in such containers invariably exhibit the same pattern of root growth. The roots in vertically oriented containers will grow laterally toward the vertical walls of the container, then down along the vertical walls to the base of the pot. Once the roots have reached the base of the pot almost all further root growth will be in circles around the interior of the base. One can observe this phenomenon when removing an established plant from such a container for repotting. There will invariably be a thick coil of roots at the base of the soil, a less vigorous column of roots along the exterior circumference of the soil and virtually no roots at the surface or in the interior of the soil. Most roots of potted plants do not, in fact, grow in the soil at all. Instead, they grow between the soil and either the exterior wall of the container or, most vigorously, between the base of the container and the soil.

The reasons for this become obvious when one examines the physics of water in a vertically oriented growing container. Gravity will pull water from the surface until it reaches hydrostatic equilibrium. When water is added from above, the typical method of irrigation, to a vertically oriented container it will drain more easily along the interior walls of the container, where it finds less resistance than it does in the center of the soil mass. Once water has reached equilibrium within a vertically oriented container the ratio of water to soil and air will generally be greatest at the base of the container and least at the surface. Water will tend to pool on the base of the container; hence root growth will be concentrated there.

Bonsai growers have known for centuries that pots with a primarily horizontal orientation, meaning that the ratio of base to vertical walls much less than one to one, provides the most efficient environment for root growth. Imagine two growing containers: container A has a wall to base surface ratio of 6 to 1 and container B has a wall to base surface ratio of 0.5 to 1. The laws of fluid dynamics will not allow container A to hold as much water at equilibrium than container B. Further, the soil or other growing medium in Container A will be disproportionately drier in the top portion of the container and disproportionately saturated in the bottom portion of the container. Container B will reach hydrostatic equilibrium with a greater percentage of the soil more evenly hydrated than in Container A. Container A is typical of the kinds of vertical growing containers used by most plant growers. Container B is shaped like a bonsai pot.

Container B offers proportionally more surface area at the base of the growing container than does Container A. The soil in Container B will reach hydrostatic equilibrium when a greater percentage of soil is adequately hydrated than in Container A. Therefore, root growth will be stronger and less confined to the base of Container B and more evenly distributed within the soil or other growing medium than in Container A. So, root growth, which is fundamental to plant health, can most effectively be fostered in a horizontally oriented pot as opposed to a vertically oriented pot.

It can be challenging to provide the best growing conditions in a container environment. Conditions from day to day and even conditions within a single container at a single time can range from sopping wet to bone dry. Either condition can be very damaging or even fatal to plants. The ideal growing conditions for most common plants are in a soil or other growing medium that ranges from humid to moist rather than dry to soaking. Plants require not only a water source but also an oxygen source for their roots for survival.

Vertically oriented growing containers can end up with both very dry and very wet soil, but proportionally little moist or humid soil. Soil or soilless growing mixes have been specially formulated to combat these conditions with materials that provide capillary wicking action to reduce saturation in some areas and to increase moisture in other areas. Horizontally oriented growing containers offer a proportionately larger area of appropriately moist or humid soil mass at hydrostatic equilibrium, but also have a proportionately larger surface area which leads to more rapid evaporation.

Ideally, one would provide water at whatever frequency was required to maintain ideal growing conditions in a container. However, most casual growers find it difficult to monitor their potted plants closely enough to do this. Also, plants become like pets, requiring attendants when their owners are away from home for any length of time.

For these and other reasons there has been much interest in automated watering systems that can insure ideal growing conditions for the longest possible time in a growing container. Solutions have ranged from mechanical drip or misting systems triggered by timers, meters, or moisture sensors to reservoirs and wicking systems. Some of the mechanical systems work quite well, but they may be prone to various failures, which can lead to catastrophic results with plants. Mechanical solutions can also be awkward or difficult to use.

Reservoirs and wicking systems can provide an environment within a growing medium that constantly provides ideal growing conditions as long as there is water in the system. Several commercially available container systems now include reservoirs and/or capillary wicks. These systems can create an environment in which moisture typically rises from a reservoir at the bottom of a container, although some systems may store water at other locations than the bottom of the container.

There are several drawbacks to the commercially available container systems using reservoirs. First, as was discussed earlier, it is very difficult to provide ideal growing conditions throughout the soil mass of a vertically oriented container. All known commercially available systems of this type are based on vertically oriented containers, so they share the inefficiencies and problems of conventional vertically oriented containers. Second, while a vertically oriented container system that includes a reservoir may work well for established plants it may require that the user waters the surface from above for an extended period of time before the benefits of the reservoir can aid root growth. Users are often unaware of this problem, which sometimes leads to failure. Third, it can be easy to overlook filling the reservoir with many of the commercially available watering systems. Some systems overcome this problem by providing visual aids or moisture sensors. Finally, it may be awkward to fill a reservoir and overfilling can oversaturate the soil in the area of most highly concentrated root growth.

### SUMMARY OF THE INVENTION

This invention resides in a container system designed to provide ideal watering and aeration conditions for plants for an extended period of time with no mechanical intervention. The system comprises a tray having a bottom surface. An insert with an upper surface and a lower surface is placed in the tray forming an upper space above the insert for the addition of a growth medium, and a lower space below the insert forming a water reservoir. One or more perforated baskets extending from the lower surface of the insert and into the water reservoir draw water from the reservoir and into the growth medium. The perforated baskets may be filled with growth medium or a wicking material such as Orlon® or other acrylic fibers. A layer of air is established above the surface of the water beneath the insert, and at least one perforated post, preferably a slotted cone extending upwardly from the insert, provides air circulation to the growth medium.

In one embodiment, a port through the insert enables an inverted water vessel to be coupled to the port to provide water to the water reservoir. The system may optionally include a plurality of rods connecting the tray to an upper hook for hanging. As a further option, the system may include a first set of elongate members for connecting the tray to an upper hook for hanging, and a second set of elongate members for connecting the tray to a second, lower tray. With the exception of the water vessel, which may be glass, the components are preferably molded plastic and provided in a kit form enabling the containers to be stacked for shipment prior to assembly.

### BRIEF DESCRIPTION OF THE DRAWINGS

FIG. 1 is a top-down, oblique drawing of one preferred embodiment of the invention;

FIG. 2 is a bottom, oblique drawing of the embodiment of FIG. 1;

FIG. 3 is an oblique drawing of a container tray;

FIG. 4 is a top-down, oblique drawing of a removable insert with a plurality of screened baskets;

FIG. 5 is a bottom, oblique drawing of the removable insert of FIG. 4;

FIG. 6 is a drawing of an optional connector for hanging;

FIG. 7 is a drawing of hanger spacer;

FIG. 8 is a top-down, oblique drawing of an embodiment of the invention wherein multiple containers may be suspended from a common hanger;

FIG. 9 is a bottom, oblique drawing of the embodiment of FIG. 8;

FIG. 10 is an oblique drawing of an alternative container tray;

FIG. 11 is a bottom view of the container tray of FIG. 10;

FIG. 12 is a top-down, oblique drawing of a removable insert with a central screened basket; and

FIG. 13 is a bottom, oblique drawing of the removable insert of FIG. 12.

### DETAILED DESCRIPTION OF THE INVENTION

This invention resides in a container system designed to provide ideal watering and aeration conditions for plants for an extended period of time with no mechanical intervention. One embodiment combines the advantages of horizontal growing containers with a self-regulating water reservoir optionally fed by a decorative glass or plastic water tower providing constant visual feedback to let the grower know when to add water to the system. Conveniently, a wine bottle, chosen by the grower, may function as a decorative glass water tower. An alternative embodiment forgoes an inverted watering vessel in favor of vertically coupling multiple containers.

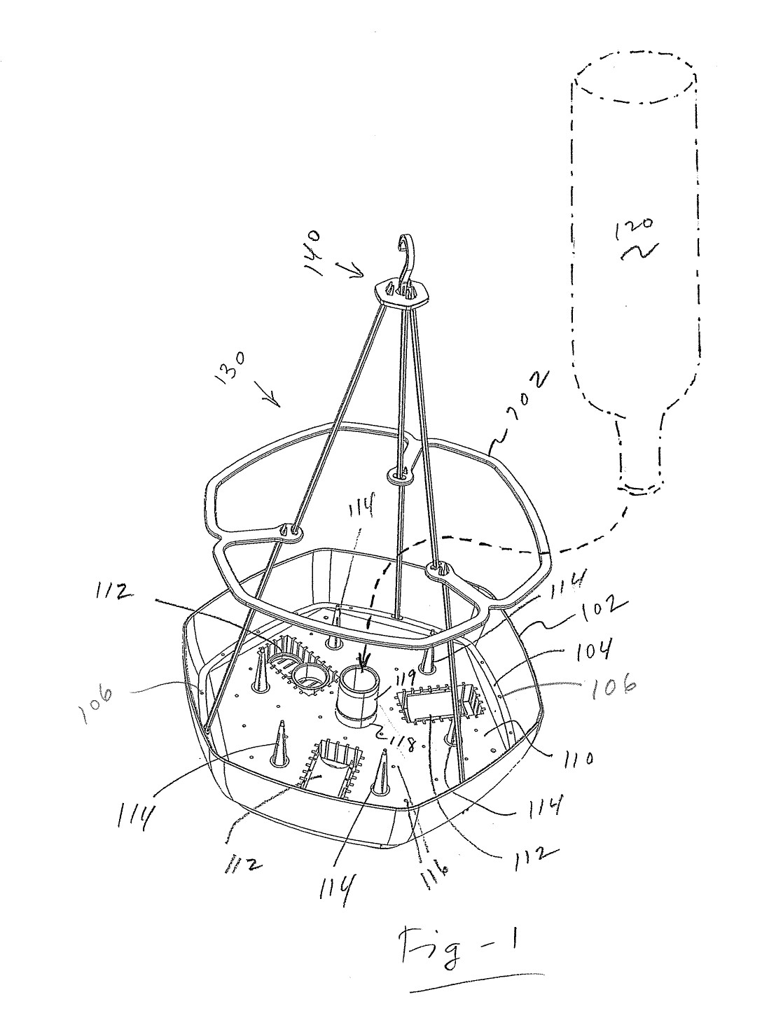

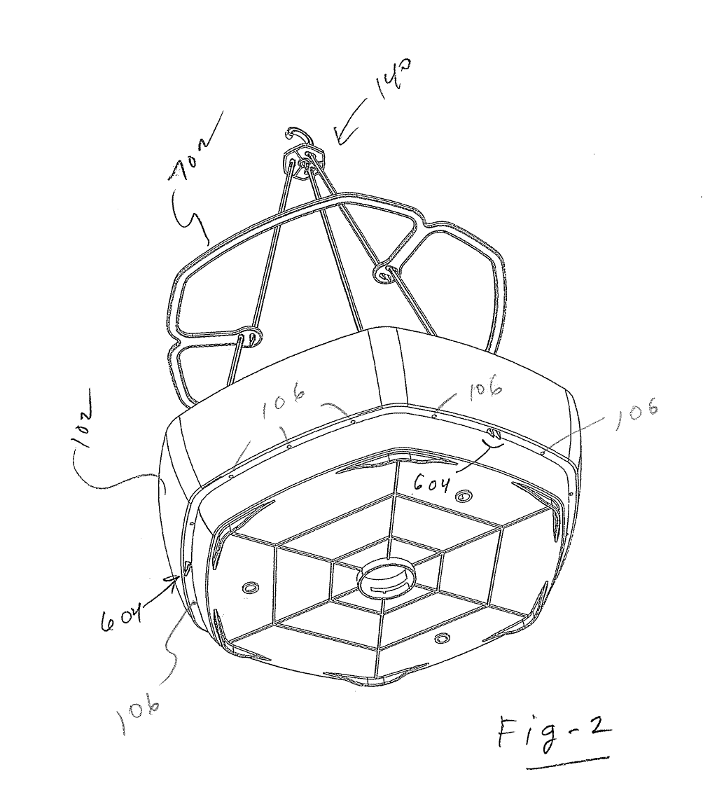

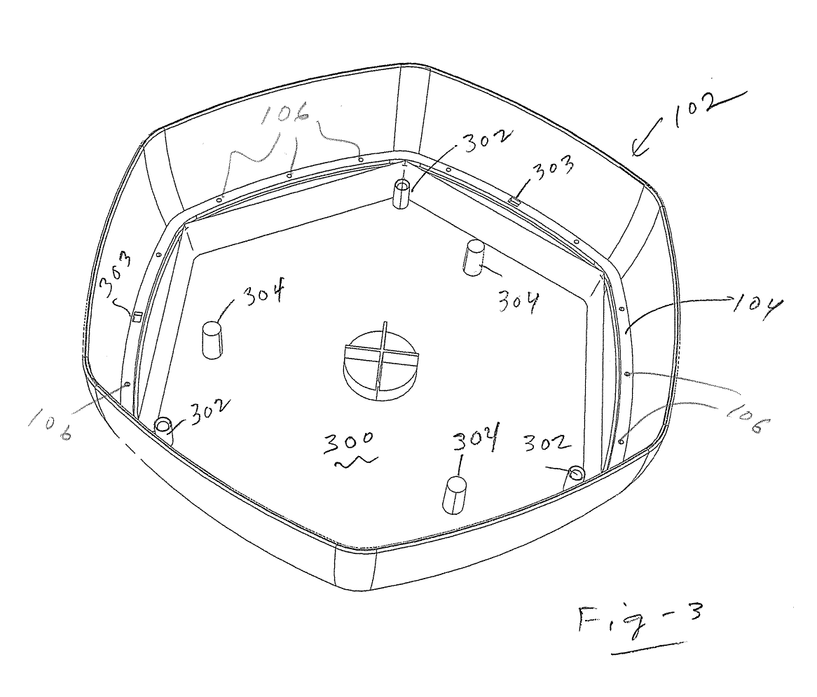

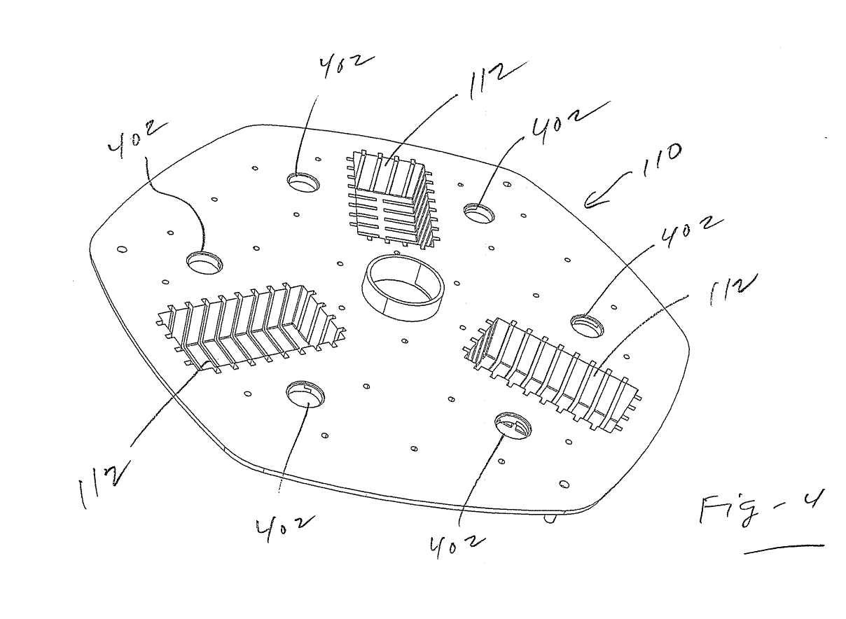

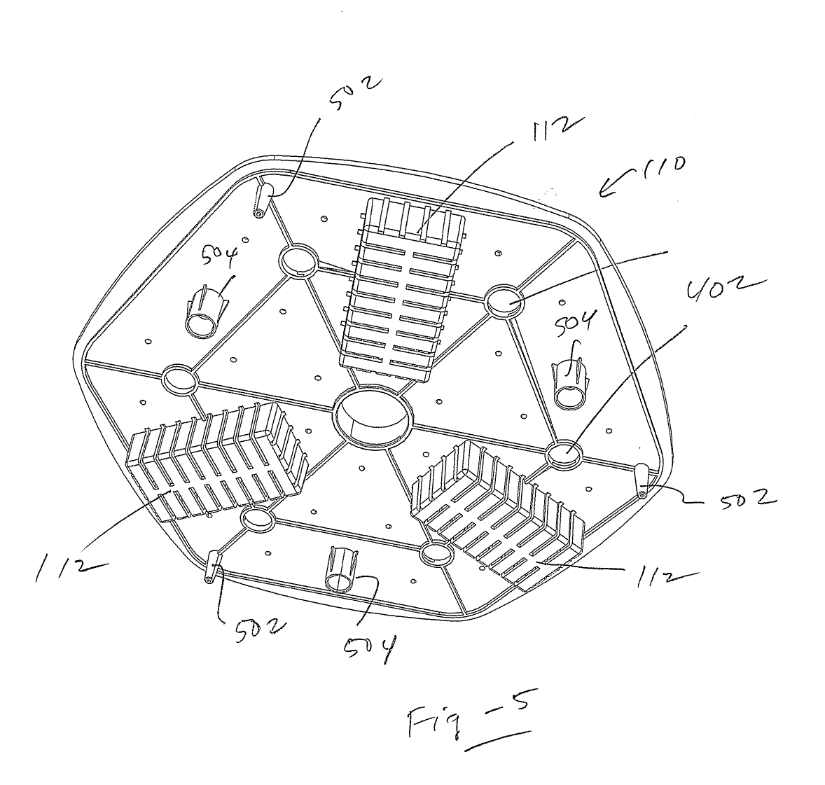

FIG. 1 is a top-down, oblique drawing of one preferred embodiment of the invention, and FIG. 2 is a bottom, oblique drawing of the embodiment of FIG. 1. The system comprises a container 102 configured to receive a removable insert 110 with one or more screened baskets 112 discussed in further detail below. FIG. 3 is an oblique drawing of the container tray. FIG. 4 is a top-down, oblique drawing of the removable insert with screened basket(s). FIG. 5 is a bottom, oblique drawing of the removable insert. All of these components are preferably made of molded plastic.

To secure the relative positioning of the insert 110 in the container 102, the bottom surface of the insert 110 may include posts 502 and sockets 504 which respectively cooperate with sockets 302 and posts 304 extending upwardly from the bottom surface 300 of the container 102 as shown in FIG. 3. These posts and sockets may be loosely received within each other as the spacing of the 110 above the bottom of the container may be fixed by the baskets 112 ‘bottoming out’ against the bottom of the container 102.

The insert 110 is spaced apart from the bottom of the container 102, and acts as a shelf, separating growing media added above the shelf (not shown) from a water reservoir below the insert. The insert 110 may or may not contain drainage holes such as 116, depending on whether the system is intended for indoor or outdoor use. The insert 110 also includes a plurality of up-standing slotted cones 114 which are removable inserted into holes in the insert 110. A central port receives a spacer tube 118 which, in turn, receives an inverted water vessel such as wine bottle 120.

In use, the insert 110 is placed in the container 102 and the volume above the insert 110 is filled with growing media and plants or seeds. The screened baskets 112, which preferably extend to the bottom surface of the container, may contain capillary wicks, but if not, they, too, are filled with soil or other growing media when added to the system. A water-containing vessel such as bottle 120 is inverted and placed onto the receptacle 118 and into tube 119 with, or without a screened base, to a height sufficient to provide support for the desired watering vessel. The water from the container flows into the reservoir portion of the system below the level of the insert 110. Indeed, the arrangement is such that when the reservoir is filled with water to capacity, a thin layer of air is established between the surface of the water and the bottom surface of the insert to allow for air circulation. If the container is over-watered from being outside in the rain, for example, the excess water is drained through holes 106, siphoning excess moisture from the growth medium. This, along with the fact that air pockets always remain under the insert, maintains the air layer under the insert.

Once assembled, the combination of the inverted water supply, screened baskets 112 and slotted cones provide an ideal horizontal growing environment which happens to be horizontally oriented in the sense that the growth medium is wider than it is tall. The screened baskets take up water from the reservoir portion which is refilled from the vessel 120 as needed, keeping the growing media at desired moisture content. The watering vessel suspends a column of water above the reservoir with a vacuum, acting as a water tower. When root, soil or other capillary wicking action lowers the water depth in the reservoir enough to temporarily break the vacuum, water will drain out of the tower until a new vacuum is created when the water level reaches the level of the base of the tower. At the same time, the slotted cones 114, being in communication with the air layer beneath insert 110, allow air circulation to extend upwards into the growth media, making air more available to roots and promoting uniform moisture throughout the soil column.

The glass or plastic water tower may or may not be provided with the container system. Depending on the size of the container system, the tube 119 extending from the surface of the insert may be sized to accept a standard wine bottle as its decorative water tower, and may incorporate multiple collars designed to accept differing wine bottle styles. This allows growers to customize their container systems according to their own tastes. The system may or may not include soil, organic and/or inorganic growing media, and/or synthetic wicking material.

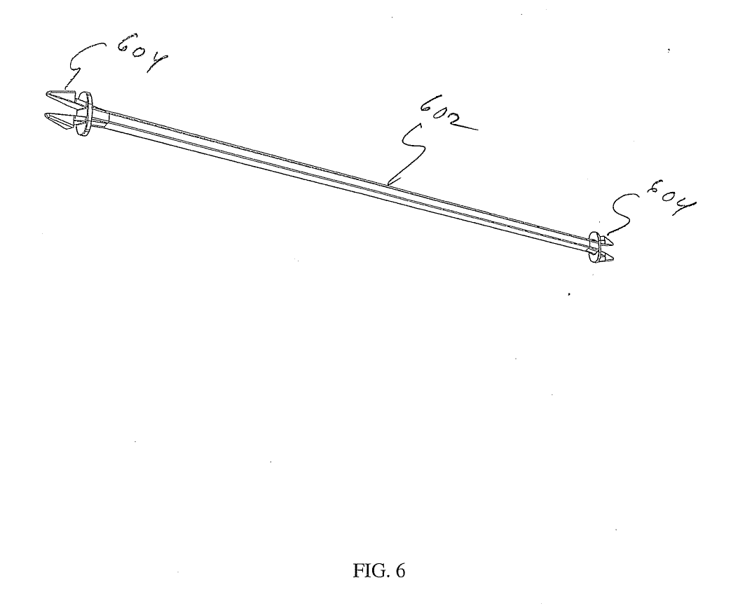

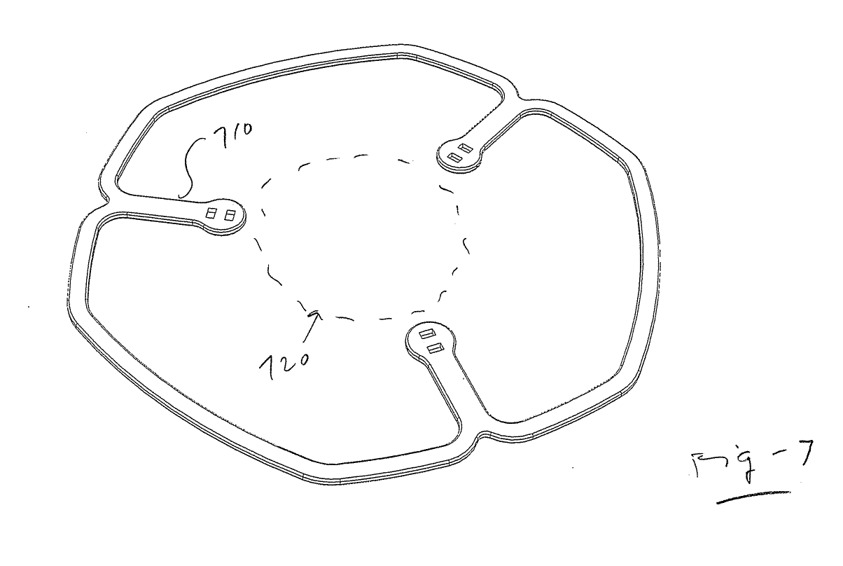

FIG. 1 illustrates an optional connector system 130 that may be used to form a free standing planting frame, or used to hang one container from another, as described in further detail below. The connector uses rods 602 with end clips 604 shown in FIG. 6. The clips 604 may be used to attach the drainage holes penetrating through square apertures 303 through a shelf 104 on the interior of the container, or from below the shelf 104 on the exterior of the container. FIG. 2 shows the clips 604 penetrating through the shelf 106, though it will be appreciated that the connectors may be clipped from the bottom up as well. An optional, intermediate spacer 702 shown in FIGS. 1, 7 may be used to extend the length of the hanging rods, the upper ends of which connect to an upper hanger unit 140. As shown in FIG. 7, the intermediate spacer 702 preferably include inwardly oriented members 710 forming an inner space 720 indicated with broken lines which forms a support for the water column.

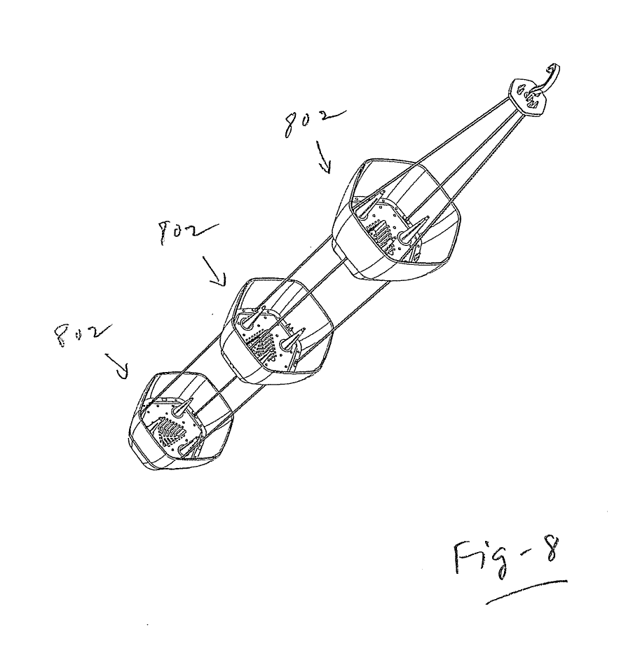

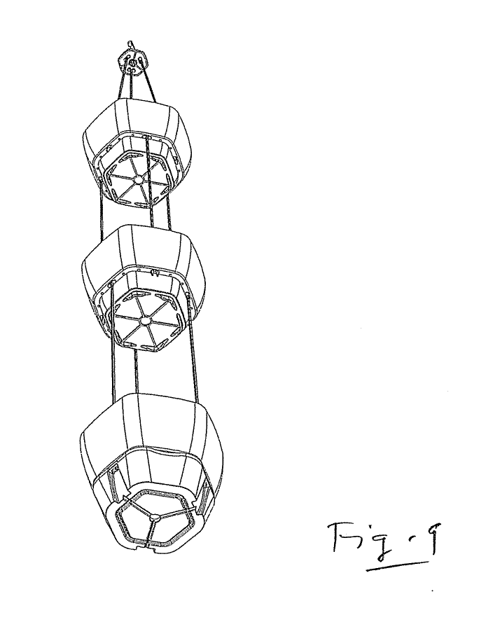

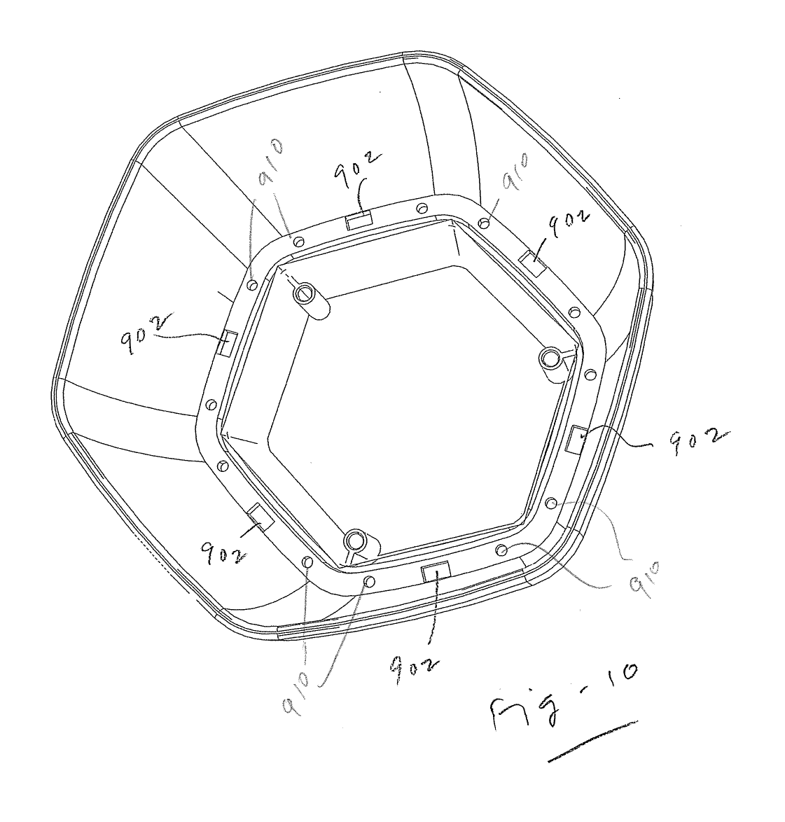

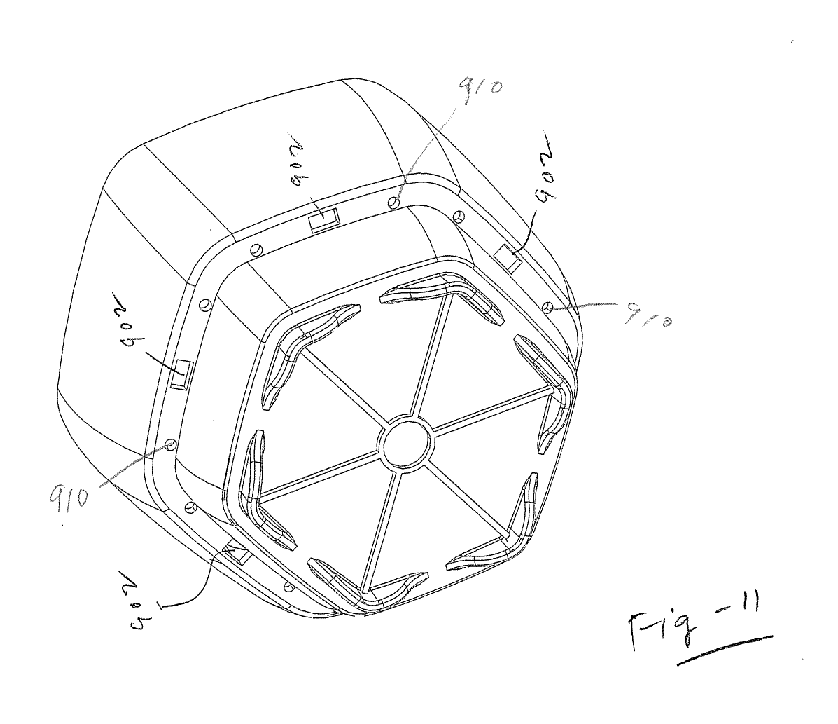

FIG. 8 is a top-down, oblique drawing of an embodiment of the invention wherein multiple containers may be suspended from a common hanger, and FIG. 9 is a bottom, oblique drawing of the embodiment of FIG. 8. FIG. 10 is an oblique drawing of an alternative container tray, and FIG. 11 is a bottom view of the container tray of FIG. 10. Note that, in this embodiment, a larger number of apertures 902 are provided, enabling a plurality of containers 802 to be stacked vertically as shown in FIG. 8.

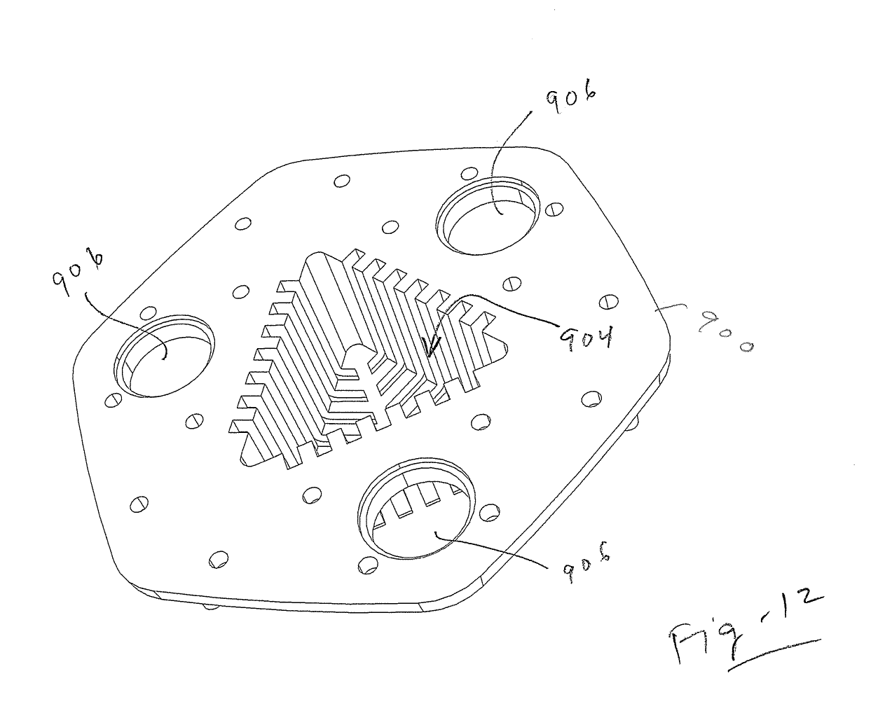

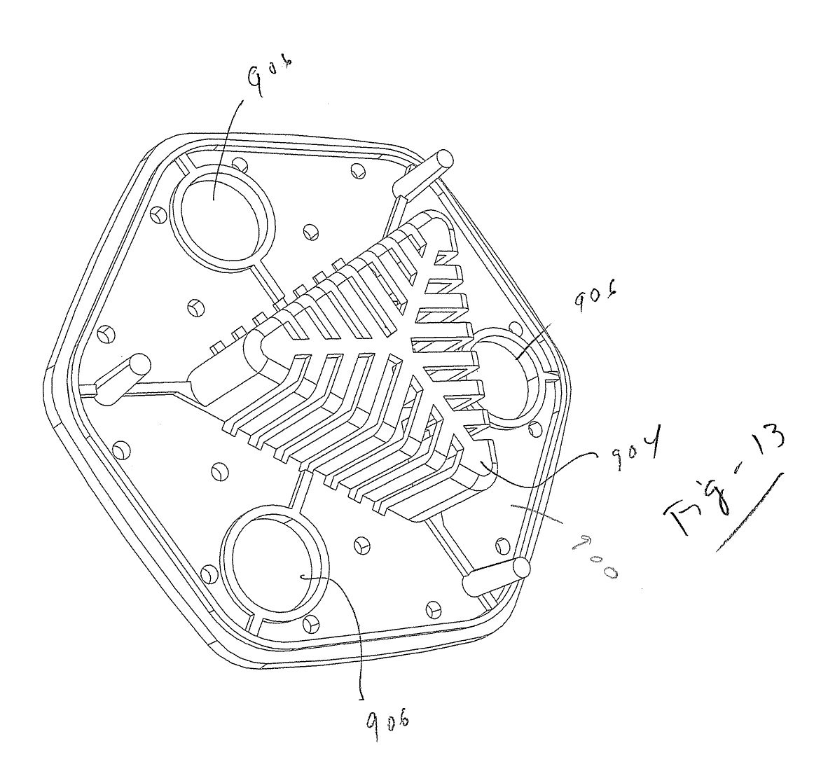

This alternative embodiment does not have a provision for an inverted watering vessel, but does include perforated baskets and posts/cones for water wicking and aeration, respectively. FIG. 12 is a top-down, oblique drawing of an alternative removable insert 900 with a central screened basket, and FIG. 13 is a bottom, oblique drawing of the removable insert of FIG. 12. Note that, in this embodiment, only a single screened basket 904 is provided with a fewer number of holes to receive a smaller number of slotted cones. As with the embodiment previously described, a layer of air is maintained above the water level and below the insert to provide for air circulation through the slotted cones. And again, if overwatering occurs, drainage holes 910 siphon out excess moisture and so that the air layer is maintained beneath the insert.

Although the containers disclosed herein are shown as being hexagonal, other polygonal and circular or oval shapes may alternatively be used. Note further that the containers of FIGS. 8-11 are somewhat small and less ‘horizontal’ than the container shown in FIGS. 1-3 and, in fact, vertical containers may be accommodated.

I claim:

1. A container system for growing plants, comprising:
a tray having a bottom surface;
an insert with an upper surface and a lower surface placed in the tray forming an upper space above the insert for the addition of a growth medium, and a lower space below the insert forming a water reservoir;
one or more perforated baskets extending from the lower surface of the insert and into the water reservoir to draw water from the reservoir and into the growth medium; and
at least one aperture in the insert coupled to a perforated post extending upwardly form the upper surface of the insert providing aeration to the growth medium.

2. The system of claim 1, further including a port through the insert enabling an inverted water vessel to be coupled to the port to provide water to the water reservoir.

3. The system of claim 1, wherein the perforated post is a slotted cone.

4. The system of claim 1, wherein the perforated baskets are filled with the growth medium or a wicking material.

5. The system of claim 1, wherein the tray is wider than it is tall.

6. The system of claim 1, wherein the port is configured to receive an existing wine bottle as a water vessel.

7. The system of claim 1, further including a plurality of rods connecting the tray to an upper hook for hanging.

8. The system of claim 1, further including:
a first set of elongate members for connecting the tray to an upper hook for hanging; and
one or more additional sets of elongate members for connecting vertically connecting one or more additional trays.

9. The system of claim 1 wherein:
even when the tray is filled to capacity, a layer of air is established between the surface of the water and the lower surface of the insert; and
the perforated posts are in communication with the layer of air through the insert.

10. The system of claim 1 wherein:
even when the tray is filled to capacity, a layer of air is established between the surface of the water and the lower surface of the insert, with the perforated posts being in communication with the layer of air through the insert; and
the tray further includes a plurality of drainage holes at or below the level of the insert, such that if the tray is overfilled, the water drains out the holes to maintain the layer of air beneath the lower surface of the insert.
